(19) United States
(12) Patent Application Publication
(10) Pub. No.: US 2008/0159084 A1
(43) Pub. Date: Jul. 3, 2008

(54) Self-Locking Expansion Device For a Watch

(76) Inventor: Roland Iten, Lausanne (CH)

Correspondence Address: IP Patent Docketing;KIRKPATRICK & LOCKHART PRESTON GATES ELLIS LLP, 599 Lexington Avenue, 33rd Floor, New York, NY, 10022-6030, US

(21) Appl. No.: 11/817,424

(22) PCT Filed: Feb. 28, 2006
(86) PCT No.: PCT/IB2006/000415

§ 371 Date: Aug. 30, 2007

(30) Foreign Application Priority Data
Mar. 4, 2005 (EP) 05101715.0

(51) Int. Cl. G04B 37/14; A44C 5/24

(52) U.S. Cl. 368/282

(57) ABSTRACT

A self-locking expansion device which connects a watchcase (1) to two ends of a strap or bracelet (2), comprises a first and a second deployable elements (3, 4), each having one end pivotally connected, or arranged to be pivotally connected, to an end of the strap or the bracelet (2), and another end pivotally connected directly or indirectly to the watchcase (1) between a locked position and an unlocked position. Said deployable elements (3, 4) are so shaped that in the locked position they are confined under the back of the watchcase (1), or lie either against the circumference of the watchcase (1), or over the front of the watchcase (1). The deployable elements (3, 4) are movable between the locked and the unlocked position by turning the watchcase (1) while the ends of the strap or bracelet (2) move together or apart.

The present invention relates to a self locking expansion device for a watch, more particularly to a self locking expansion device which can for example be hidden under the back of a watchcase in a locked position.

Deployable closure devices are part of the prior art. Such devices are generally made up of three hinged parts, namely a central body at each end of which a shorter side part is connected. These side parts are able to be folded or pivoted back onto the outer face of the central body, and immobilized on the body by cooperating locking means provided on the body and on each side part.

Such closure devices have the disadvantage in that after a certain number of repeated cycles of opening and closing, wear occurs which can weaken the latch effect resulting in unwanted opening of the closure device. CH 689 931 discloses a mechanism which prevent unwanted opening of said closure device.

However, said above-mentioned device is visible and affects the esthetics of the bracelet of a watch.

The aim of the present invention is to propose a reliable self-locking expansion device for a watch, said device being originally concealed or arranged in an aesthetic manner either on the back, or front, or on the periphery of a watchcase as to improve the aesthetics of the watch.

This aim is achieved by a self-locking expansion device as set out in claim 1. This device, which connects a watchcase to two ends of a strap or bracelet, comprises a first and a second deployable elements, each having one end pivotally connected, or arranged to be pivotally connected, to an end of the strap or the bracelet and another end pivotally connected directly or indirectly to the watchcase between an unlocked position and a locked position. Said deployable elements are so shaped that in the locked position they are confined under the back of the watchcase, or lie either against the circumference of the watchcase, or over the front of the watchcase. The deployable elements are movable between the locked and the unlocked position by turning the watchcase while the ends of the strap or bracelet move together or apart.

The invention will be better understood thanks to the following detailed description of several embodiments with reference to the attached drawings, in which:

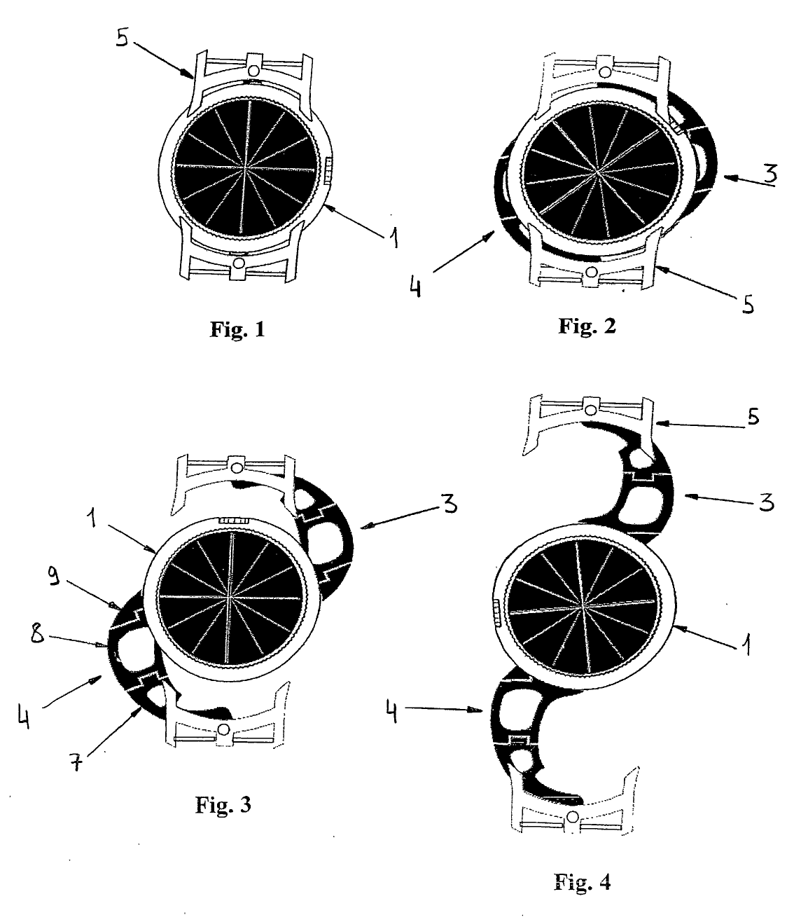

FIG. 1 represents a top view of the watchcase showing two connecting elements for strap or bracelet, when the self-locking expansion device is in a locked position.

FIG. 2 represents a top view of the watchcase when it has slightly been turned counter clockwise.

FIG. 3 represents a top view of the watchcase when it has been turned counter clockwise 90 degrees while the two connecting elements move apart.

FIG. 4 represents a top view of the watchcase when it has been turned counter clockwise 180 degrees and the deployable elements are completely expanded.

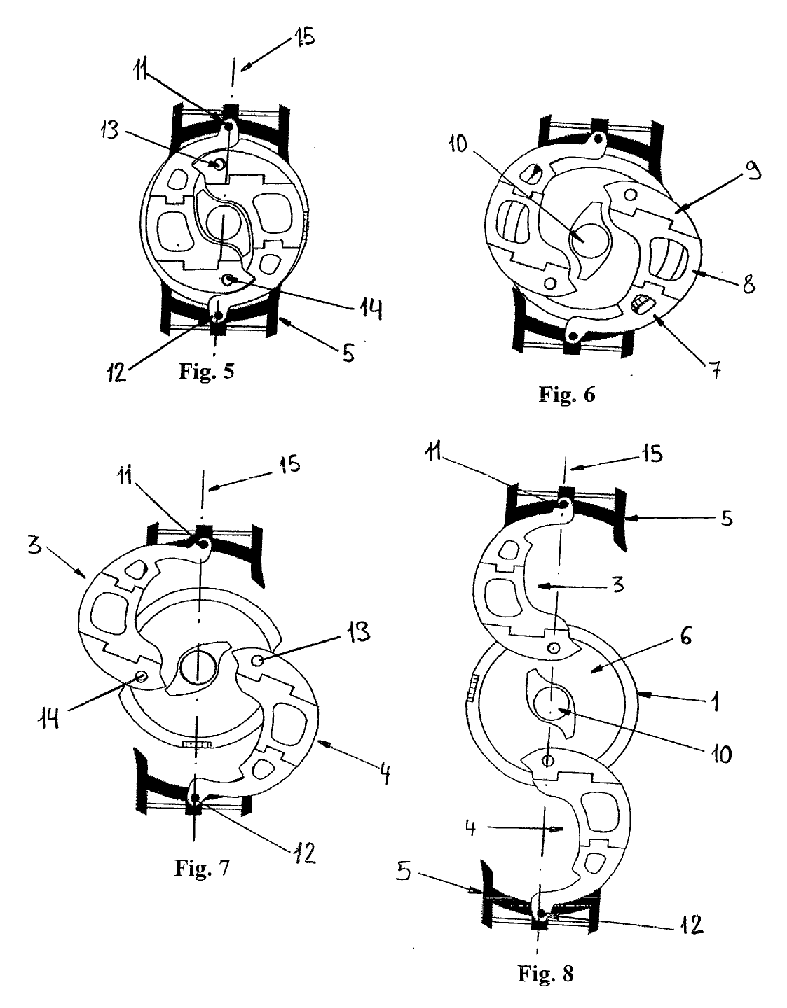

FIGS. 5 to 8 represent the bottom view of said watchcase with the deployable elements corresponding to the difference sequences of the expansion of the self-locking expansion device illustrated by FIGS. 1 to 4.

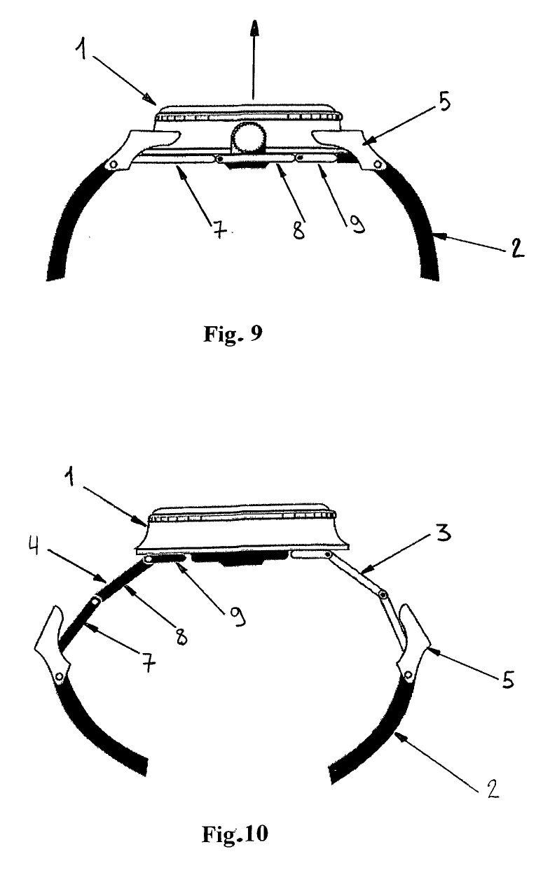

FIG. 9 represents a partial side view of the watch when the self-locking expansion device is in a locked position.

FIG. 10 represents a partial side view of the watch when the self-locking expansion device is in an unlocked position with the deployable elements completely expanded.

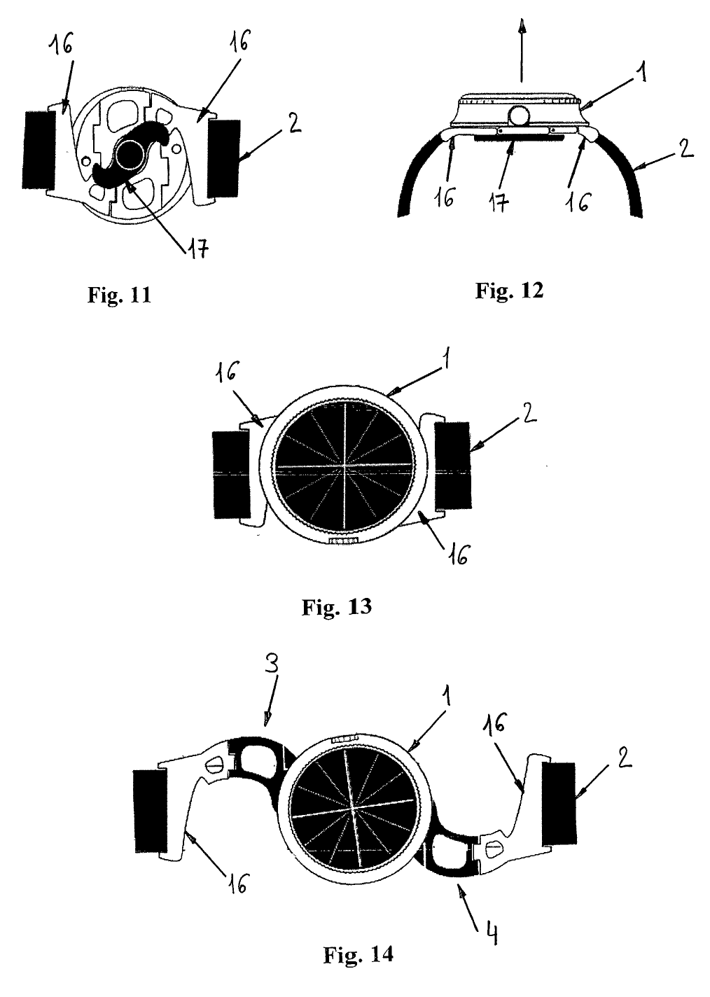

FIG. 11 represents a bottom view of the watchcase according to a variant of the first embodiment of the invention when the self-locking expansion device is in the locked position.

FIG. 12 represents a side view of FIG. 11.

FIG. 13 represents a top view of FIG. 12.

FIG. 14 represents a top view of the watch of FIG. 13 when the self-locking expansion device is in the unlocked position with the deployable elements fully expanded.

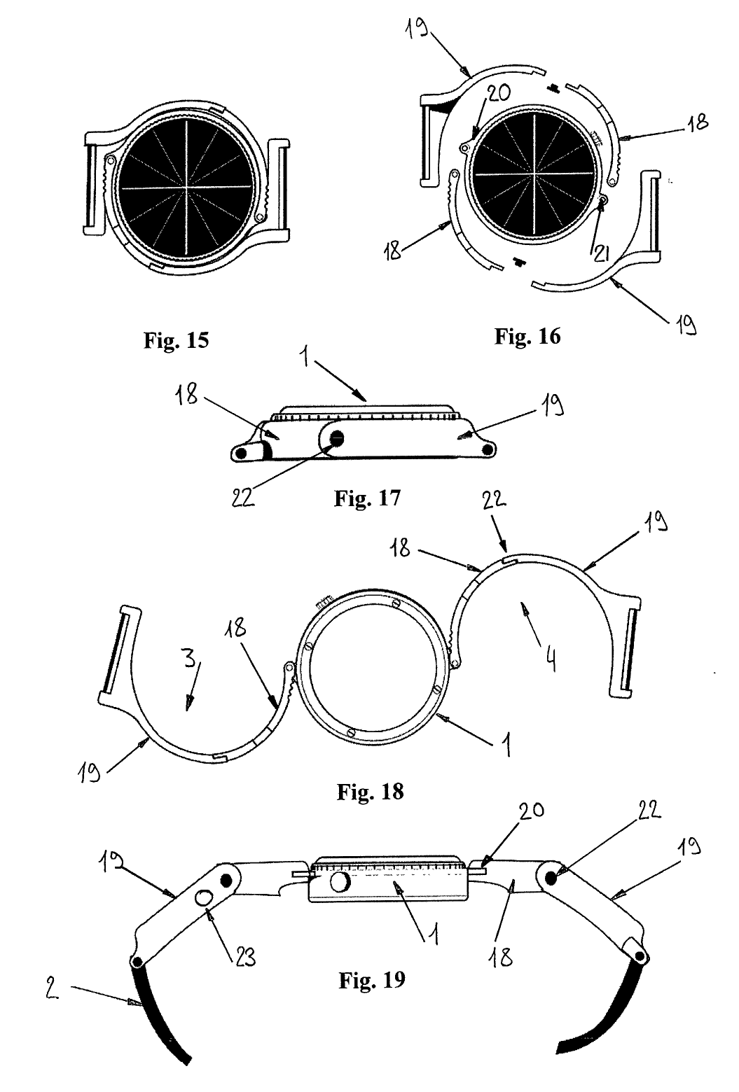

FIG. 15 represents a top view of the watchcase according to a second embodiment of the present invention when the self-locking expansion device is in the locked position.

FIG. 16 represents an exploded view of FIG. 15.

FIG. 17 represents a side view of the watchcase of FIG. 15.

FIG. 18 represents a top view of the watchcase of FIG. 15 when the self-locking expansion device is in the unlocked position with the deployable elements completely expanded.

FIG. 19 represents a side view of FIG. 18.

According to a preferred embodiment of the present invention shown by FIGS. 1 to 10, the self-locking expansion device for connecting the watchcase (1) to two ends of a strap or bracelet (2), comprises first and second deployable elements (3, 4). The first and the second deployable elements (3, 4) have one end pivotally connected to a hook element (5) connected to one end of the strap or the bracelet (2) on a first and on a second axis (11, 12) and another end pivotally connected to a disc (6) fixed under the back of the watchcase (1) on a third and on a fourth axis (13, 14).

The deployable elements (3, 4) are made up of 3 different parts (7, 8, 9) articulated to each other by hinges as to allow said elements (3, 4) to be fully deployed in the extension of the strap or bracelet (2) (FIG. 10) when the self-locking expansion device is completely unlocked.

In this example, the deployable elements (3, 4) are so shaped that in the locked position they are confined under the back of the watchcase (1). A decorative element (10) is located in the center of the back of the watchcase (1), the contours of said decorative element (10) and of said deployable elements (3, 4) ensure that said elements (3, 4) are nested adjacent to the decorative element (10) in the locked position.

The deployable elements (3, 4) are movable between the locked and the unlocked position by turning the watchcase (1). As seen by FIG. 4, the watchcase (1) must be rotated 180 degrees counter clockwise in order to ensure that the elements (3, 4) are fully deployed, assuring both an easy placement of the watch on the wrist and an easy removal of the watch from the wrist.

These deployable elements (3, 4) are retracted and completely confined under the back of the watchcase (1), when the watchcase (1) is rotated 180 degrees clockwise in order to bring both hook elements (5), which are connected to each end of the strap or the bracelet (2), against a portion of the circumference of the watchcase (1) to ensure that the bracelet securely holds the wrist. Said hook elements (5) are shaped as to rest firmly against said portion of the circumference of the watchcase (1) when the deployable elements (3, 4) are confined under the back of the watchcase (1) and to assure that said elements (3, 4) stay retracted and completely confined under the watchcase (1) even when the latter is pulled along a vertical axis as shown in FIG. 9.

One end of each deployable element (3, 4) is pivotally connected to the hook element (5) about the first and the second axis (11, 12), said axes being parallel to and spaced from each other when said elements (3, 4) are confined under the back of the watchcase (1) in the locked position causing tension line holding said elements (3, 4) in a stable position.

These deployable elements (3, 4) are rotatably deployed when the watchcase (1) is turned counter clockwise such that the third axis (13) moves below a tension line (15), while a fourth axis (14) moves above said tension line (15), the elements (3, 4) being completely deployed and stable when the first, second, third and fourth axis (11, 12, 13, 14) are parallel to each other on said tension line (9) holding deployable elements (3, 4) in the unlocked position.

In a variant of the preferred embodiment, the first and the second deployable elements (3, 4) are two hook shaped plates which are nested adjacent each other in a “Yin Yang” position in the locked position.

In a second embodiment of the present invention, as shown by FIGS. 11 to 14, the hook elements (5) described in the first embodiment of the invention are replaced by linking elements (16) which are partially confined under the watchcase (1) in the locked position.

An element (17) is partially covering the top of the two deployable elements (3, 4) as shown by FIG. 11 to assure that said elements (3, 4) stay retracted and completely confined under the watchcase (1) even when the latter is pulled along a vertical axis as shown in FIG. 12.

In a third embodiment of the present invention (FIGS. 15 to 19), the deployable elements (3, 4) are so shaped that in a retracted position they lie against the totality of the circumference of the watchcase (1), the extension and retraction of the deployable elements (3, 4) being realized by turning the watchcase as described in the first embodiment.

Each deployable element (3, 4) is made up of a first and a second part (18, 19). One end of each first part (18) is pivotally connected to a lug (20) around a first vertical axis (21) (FIG. 16), the lug (20) being situated on the periphery of the watchcase (1), while the other end of said first part (18) is pivotally connected to the end of the second part (19) around a second horizontal axis (22). The second part (19) of one of the two deployable elements (3, 4) comprises at least one hole (23) adjustable around at least one crown of the watch when said part (19) lies against a portion of the circumference of the watchcase (1) in the retracted position.

In order to reach the extended position, the end of the first part (18) of each deployable element (3, 4) rotates around the first vertical axis (21) on the lug (20) while the end of the second part (19) rotates around the second horizontal axis (22) to the other end of the first part (18).

Even though, the described self-locking expansion device is suitable for watches, it can be used for other applications where the invention can be contemplated without departing from the scope of the invention as defined in the appended claims. For example, it can be adapted for a belt.

1. A self-locking expansion device for connecting a watchcase (1) to two ends of a strap or bracelet (2), comprising first and second deployable elements (3, 4), each having one end pivotally connected, or arranged to be pivotally connected to an end of the strap or the bracelet (2), and another end pivotally connected directly or indirectly to the watchcase (1) between a locked position and an unlocked position, wherein the deployable elements (3, 4) are so shaped that in the locked position they are confined under the back of the watchcase (1), or lie against the circumference of the watchcase (1), or lie over the front of the watchcase (1), and wherein the deployable elements (3, 4) are movable between the locked and the unlocked position by turning the watchcase (1) while the ends of the strap or bracelet (3) move together or apart.

2. A self-locking expansion device according to claim 1, characterized in that one end of each deployable element (3, 4) is connected to one end of said strap or bracelet (2) on a respective first axis and second axis (11, 12), said axes (11, 12) being parallel to and spaced from each other when said elements (3, 4) are confined under the back of the watchcase (1) in said locked position causing tension line holding said elements (3, 4) in a stable position.

3. A self-locking expansion device according to claim 2, characterized in that the other end of the first and the second deployable element (3, 4) is connected to the watchcase (1) on a third and on a fourth axis (13, 14) respectively.

4. A self-locking expansion device according to claim 3, characterized in that said deployable elements (3, 4) are rotatably deployed when the watchcase (4) is turned counter clockwise such that the third axis (13) moves below a tension line (15), while the fourth axis (14) moves above said tension line (15), said element (3, 4) being completely deployed and stable when the first, second, third and fourth axis (11, 12, 13, 14) are parallel to each other on said tension line (9).

5. A self-locking expansion device according to claim 1 characterized in that said elements (3, 4) are connected to a disc (6) which is fixed under the back of the watchcase (1).

6. A self-locking expansion device according to claim 1 characterized in that the first and the second elements (3, 4) are two hook shaped plates which are nested adjacent each other in a “Yin Yang” position in said closed position.

7. A self-locking expansion device according to claim 1 characterized in that a decorative element (10) is located in the center of the back of the watchcase (6), and the contour of both said decorative element (10) and said deployable elements (3, 4) ensures that said elements (3, 4) are nested adjacent to the decorative element (10) in said locked position.

8. A self-locking expansion device according to claim 1, characterized in that the deployable elements (3, 4) are so shaped that in the locked position they lie against the circumference of the watchcase (1).

9. A wristwatch comprising a self-locking expansion device according to claim 1.

10. A self-locking expansion device according to claim 2 characterized in that said elements (3, 4) are connected to a disc (6) which is fixed under the back of the watchcase (1).

11. A self-locking expansion device according to claim 3 characterized in that said elements (3, 4) are connected to a disc (6) which is fixed under the back of the watchcase (1).

12. A self-locking expansion device according to claim 4 characterized in that said elements (3, 4) are connected to a disc (6) which is fixed under the back of the watchcase (1).

13. A self-locking expansion device according to claim 2 characterized in that the first and the second elements (3, 4) are two hook shaped plates which are nested adjacent each other in a “Yin Yang” position in said closed position.

14. A self-locking expansion device according to claim 3 characterized in that the first and the second elements (3, 4) are two hook shaped plates which are nested adjacent each other in a “Yin Yang” position in said closed position.

15. A self-locking expansion device according to claim 4 characterized in that the first and the second elements (3, 4) are two hook shaped plates which are nested adjacent each other in a “Yin Yang” position in said closed position.

16. A self-locking expansion device according to claim 5 characterized in that the first and the second elements (3, 4) are two hook shaped plates which are nested adjacent each other in a “Yin Yang” position in said closed position.

17. A self-locking expansion device according to claim 2 characterized in that a decorative element (10) is located in the center of the back of the watchcase (6), and the contour of both said decorative element (10) and said deployable elements (3, 4) ensures that said elements (3, 4) are nested adjacent to the decorative element (10) in said locked position.

18. A self-locking expansion device according to claim 3 characterized in that a decorative element (10) is located in the center of the back of the watchcase (6), and the contour of both said decorative element (10) and said deployable elements (3, 4) ensures that said elements (3, 4) are nested adjacent to the decorative element (10) in said locked position.

19. A self-locking expansion device according to claim 4 characterized in that a decorative element (10) is located in the center of the back of the watchcase (6), and the contour of both said decorative element (10) and said deployable elements (3, 4) ensures that said elements (3, 4) are nested adjacent to the decorative element (10) in said locked position.

20. A self-locking expansion device according to claim 5 characterized in that a decorative element (10) is located in the center of the back of the watchcase (6), and the contour of both said decorative element (10) and said deployable elements (3, 4) ensures that said elements (3, 4) are nested adjacent to the decorative element (10) in said locked position.
